(19) United States
(12) Patent Application Publication
(10) Pub. No.: US 2015/0280813 A1
(43) Pub. Date: Oct. 1, 2015

(54) APPARATUS AND METHOD FOR DISTINGUISHING AMONG NON-REFLECTIVE FAULTS ON OPTICAL LINK

(71) Applicant: Electronics and Telecommunications Research Institute, Daejeon (KR)

(72) Inventor: Won-Kyoung LEE, Daejeon (KR)

(21) Appl. No.: 14/578,681

(22) Filed: Dec. 22, 2014

(30) Foreign Application Priority Data
Mar. 31, 2014 (KR) 10-2014-0038139

(51) Int. Cl. H04B 10/071

(52) U.S. Cl. CPC H04B 10/071

(57) ABSTRACT

A method of analyzing an optical link fault includes: determining whether a peak is present on an optical time domain reflectometry (OTDR) trace; in response to a determination that there is the peak on the OTDR trace, determining a fault as a reflective fault; in response to a determination that there is no peak on the OTDR trace, determining that the fault is a non-reflective fault; and reporting the optical link fault analysis result.

### CROSS-REFERENCE TO RELATED APPLICATION(S)

This application claims priority from Korean Patent Application No. 10-2014-0038139, filed on Mar. 31, 2014, in the Korean Intellectual Property Office, the disclosure of which is incorporated herein by reference in its entirety.

### BACKGROUND

1. Field

The following description relates to optical link fault diagnosis apparatus and method, and more particularly, to a fault analysis apparatus and method capable of identifying and diagnosing causes of non-reflective faults.

2. Description of the Related Art

In a situation where a passive optical network (PON) system is being developed with the focus on increasing traffic rate, extending transmission distance, and expanding the number of branches, optical link management is an important core technology in the equipment market.

The optical link management technology needs to quickly detect a fault and accurately diagnose the cause of the fault for the reduction of operation-and-maintenance expense (OPEX). It is relatively easy to identify a reflective fault caused by a fiber-cut using typical optical time domain reflectometry (OTDR)-based technology, but it has limitations in distinguishing among non-reflective faults caused by connector mismatch, fiber-bending, and temperature variation. A method of distinguishing among non-reflective faults caused by connector mismatch and fiber-bending using Brillouin frequency shift has been proposed. However, it is difficult to implement this method for commercial equipment due to a complex structure (“A high performance OTDR for measuring distributed strain and optical loss,” ECOC96). Recently, a method for distinguishing among non-reflective faults caused by connector mismatch and fiber-bending using a frequency dependency characteristic of an OTDR trace has been proposed (U.S. patent application Ser. No. 14/054,209, “Device for monitoring optical link fault and method thereof”).

### SUMMARY

The following description relates to an apparatus and method capable of identifying non-reflective faults caused by connector mismatch and fiber-bending, in addition to temperature variation, in analyzing an optical link fault.

In one general aspect, there is provided a method of analyzing an optical link fault, the method including: determining whether a peak is present on an optical time domain reflectometry (OTDR) trace; in response to a determination that the peak is on the OTDR trace, determining a fault as a reflective fault; and in response to a determination that there is no peak on the OTDR trace, determining the fault as a non-reflective fault.

In another general aspect, there is provided an apparatus for analyzing an optical link fault, the apparatus including: a peak detector configured to determine whether a peak is present on an optical time domain reflectometry (OTDR) trace; a reflective fault detector configured to, in response to a determination that a peak is present on the OTDR trace, determine a fault as a reflective fault; and a non-reflective fault detector configured to, in response to a determination that a peak is not present on the OTDR trace, determine a fault as a non-reflective fault.

Other features and aspects will be apparent from the following detailed description, the drawings, and the claims.

### BRIEF DESCRIPTION OF THE DRAWINGS

FIG. 1 is a diagram illustrating an optical link analysis system according to an exemplary embodiment.

FIG. 2 is a diagram illustrating a configuration of an apparatus for analyzing an optical link fault according to an exemplary embodiment.

FIGS. 3A to 3C are diagrams illustrating reflective faults according to an optical time domain reflectometry (OTDR)-based optical link management technique.

FIGS. 4A to 4E are diagrams explaining a non-reflective fault.

FIG. 5 is a graph illustrating a discrepancy in refractive index due to a change in refractive index profile.

FIGS. 6A and 6B are graphs showing measurements of losses due to a connector is mismatch and fiber-bending.

FIG. 7 is a diagram illustrating an experiment to measure a change in a back-scattered signal according to temperature variation.

FIG. 8 is a graph illustrating an OTDR trace that shows a change in a back-scattered signal according to temperature variation.

FIG. 9 is a flowchart illustrating a method of analyzing a fault according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

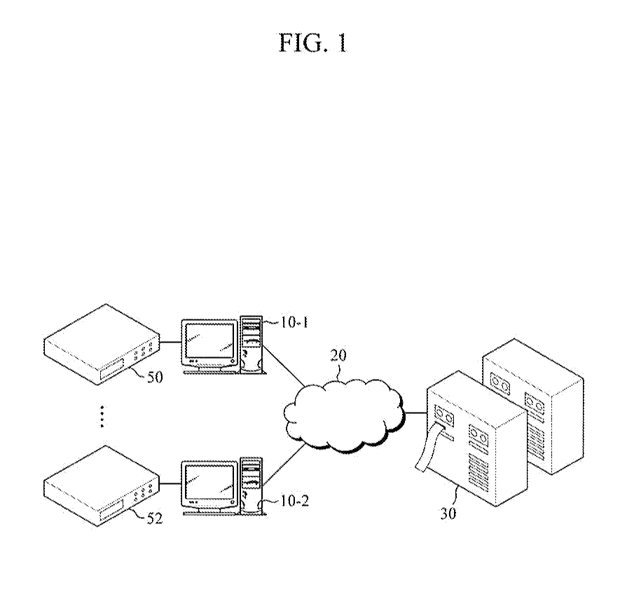

FIG. 1 is a diagram illustrating an optical link analysis system according to an exemplary embodiment.

Referring to FIG. 1, a plurality of various types of measuring instruments 50 and 52 are respectively connected to computer systems 10-1 and 10-2, while the computer systems 10-1 and 10-2 are connected to a management server 30 through a network 20, such as the Internet.

An apparatus for analyzing an optical link fault according to an exemplary embodiment may be installed in each of the computer systems 10-1 and 10-2 in the form of an application or embedded software, or may be installed in the management server 30.

A particular portion of an optical cable is measured using the measuring instruments 50 and 52, and measured waveform information is transmitted to the respective computer systems 10-1 and 10-2, which is then analyzed. Waveform information analyzed by the computer systems 10-1 and 10-2 is transmitted to the management server 30 through the Internet 20 and stored in the form of database. The stored waveform information may be utilized as basic data for a mid to long term analysis of the optical cable performance, such as monthly, quarterly or yearly change in loss. However, such configuration is only exemplary, and aspects of the present disclosure are not limited thereto.

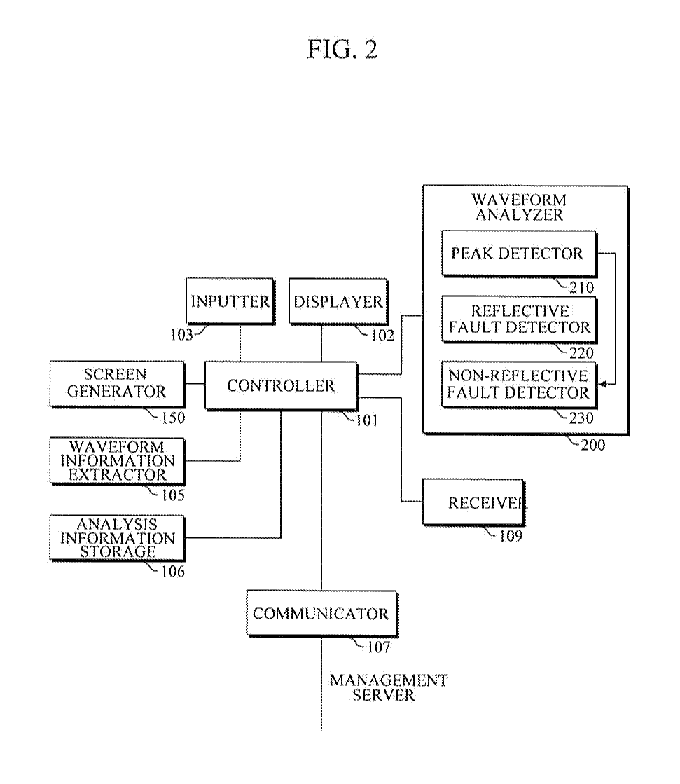

FIG. 2 is a diagram illustrating a configuration of an apparatus for analyzing an optical link fault according to an exemplary embodiment.

Referring to FIG. 2, an inputter 103 receives an input from a user, and a displayer 102 displays information analyzed under the control of a controller 101 to a monitor connected with the computer systems 10-1 and 10-2.

A receiver 109 receives waveform information from the measuring instruments 50 and 52 (refer to FIG. 1). Since the measuring instruments 50 and 52 may vary in specifications depending on manufacturer, they may omit some data specified by international standards or include other additional data.

A standard waveform information extractor 105 extracts preset standard waveform information from waveform data. The preset waveform information is essential data for analysis of measured waveform information, and may include, for example, measurement parameters, key events, and data points.

A screen generator 150 generates a screen on which obtained item information is displayed.

An analysis information storage 106 adds index information that is input by the user through the inputter 103 to the obtained item information, and stores the resulting information.

A waveform analyzer 200 analyzes extracted standard waveform information and obtains the item information associated with a preset item. Here, the item information is information about an item that indicates the state of the measured portion of the optical cable.

According to one exemplary embodiment, the waveform analyzer 200 includes a peak detector 210, a reflective fault detector 220, and a non-reflective fault detector 230.

The peak detector 210 may drive either the reflective fault detector 220 or the non-reflective fault detector 230 according to the presence or absence of a large peak on an OTDR trace.

The reflective fault detector 220 may determine that a reflective fault is caused by a s perpendicular cut made in an optical fiber when a sharp peak and an abrupt decrease in optical intensity appear on the OTDR trace. Whereas, the reflective fault detector 220 may determine that a reflective fault is caused by longitudinal connector-mismatch when there is a small peak on the OTDR trace.

The non-reflective fault detector 230 may diagnose a non-reflective fault caused by a slanted cut made in the optical fiber when an decrease in optical intensity appears on the OTDR trace without a peak; may diagnose a non-reflective fault caused by bending the optical fiber when a loss threshold is present on the OTDR trace without a peak; may diagnose a non-reflective fault caused by a lateral connector mismatch when neither peak nor loss threshold appears on the OTDR trace; and may diagnose a non-reflective fault caused by abnormal is temperature variation when a linear slope is shifted upward/downward, without a peak.

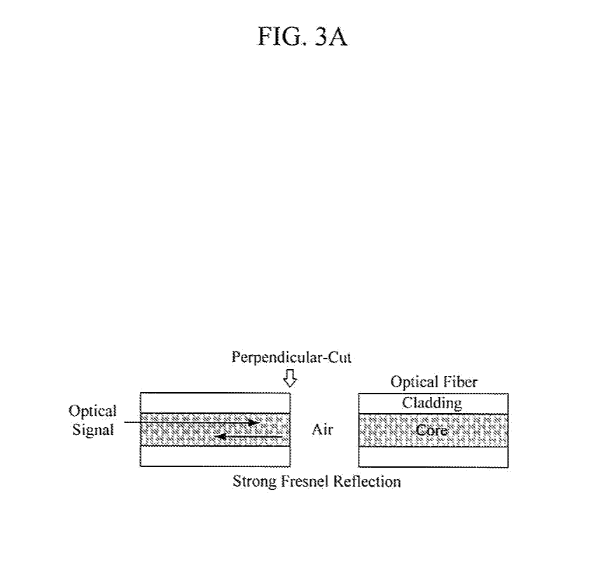

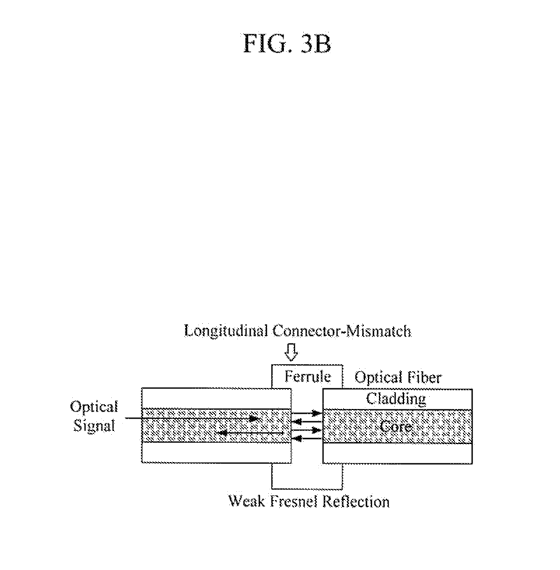

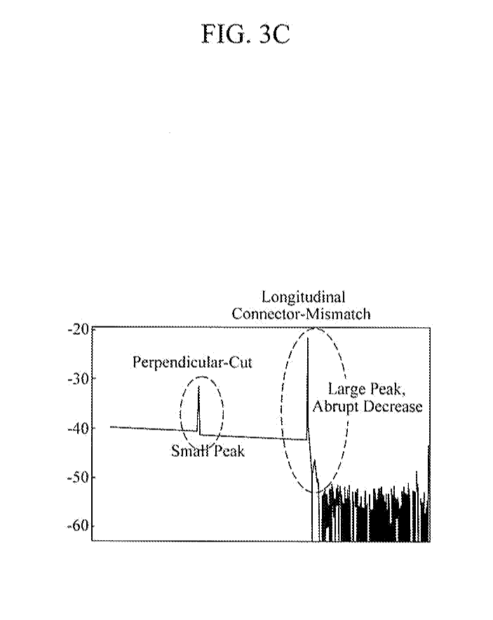

FIGS. 3A to 3C are diagrams illustrating reflective faults according to an optical time domain reflectometry (OTDR)-based optical link management technique.

Referring to FIG. 3A, a perpendicular cut made in an optical fiber may cause Fresnel reflection due to a large difference in refractive index between a core of the optical fiber and the air. Since the optical signal transmission is not possible due to the cut in the optical fiber, a sharp decrease in intensity of a reflection signal occurs.

Referring to FIG. 3B, a longitudinal connector-mismatch may cause a small peak due to a difference in refractive index between a core and a cladding of the optical fiber. Therefore, it may be possible to distinguish the reflective faults caused by the fiber cut and the longitudinal connector mismatch based on a large peak and a decrease in intensity of a received reflection signal on the OTDR trace, as shown in FIG. 3C.

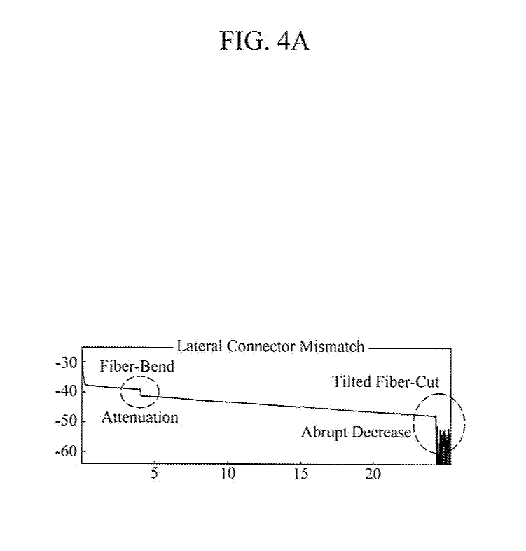

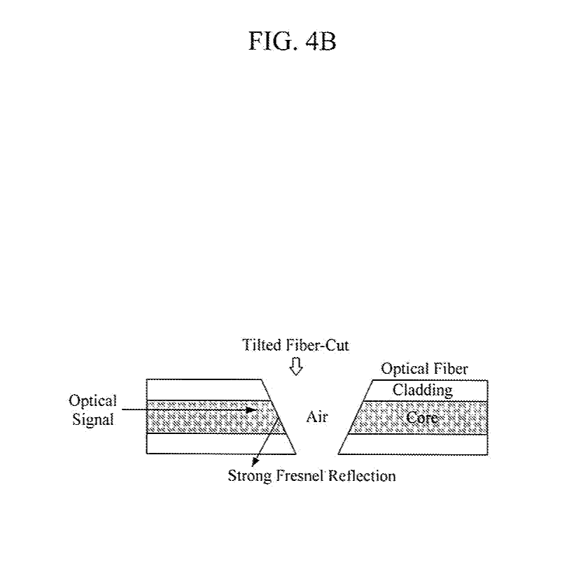

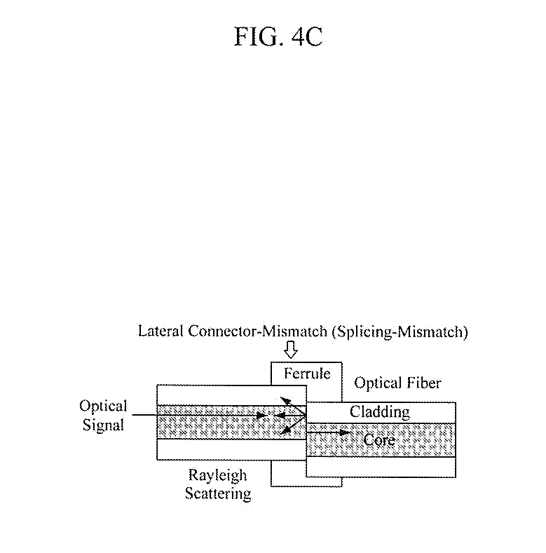

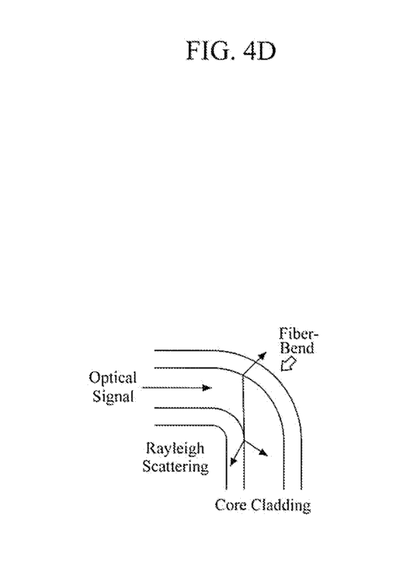

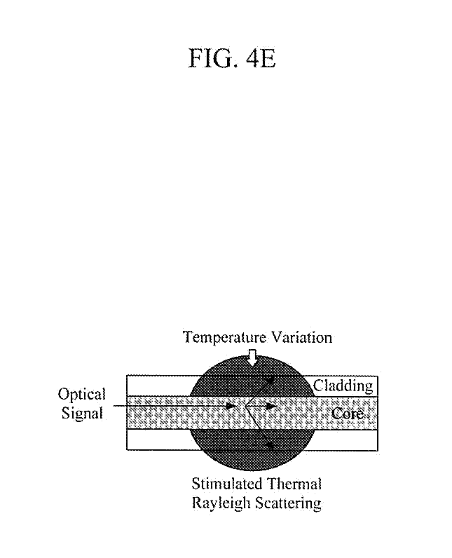

FIGS. 4A to 4E are diagrams explaining a non-reflective fault.

Referring to FIG. 4A, the non-reflective fault may not cause a peak due to reflection, and only cause a decrease in optical intensity due to Rayleigh scattering.

The Rayleigh scattering may result from a titled connector mismatch as shown in FIG. 4B, a lateral connector-mismatch as shown in FIG. 4C, fiber-bending as shown in FIG. 4D, or temperature variation as shown in FIG. 4E.

When an optical fiber is bent more than a predetermined angle, a refractive index profile of the fiber changes from an axially symmetric step-like profile to an asymmetric profile, and

Rayleigh scattering occurs due to a discrepancy in the refractive index due to the changed refractive index profile.

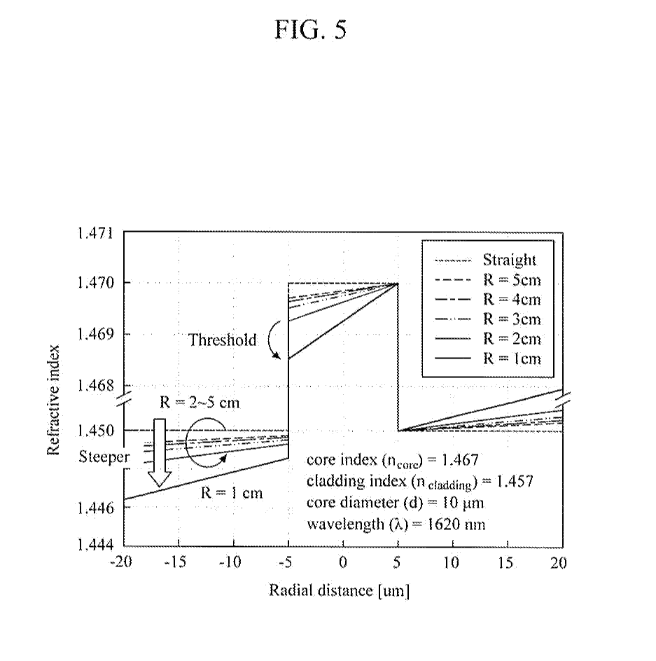

FIG. 5 is a graph illustrating a discrepancy in refractive index due to a change in refractive index profile.

Referring to FIG. 5, the smaller the bending radius is, the greater the refractive index. A decrease in optical intensity due to scattering becomes much greater when the bending radius is smaller than a threshold value.

By contrast, the connector mismatch is caused by a mismatch in mode filed diameter (MFD) between two optical fibers. The greater the mismatch in MFD is, the greater the decrease in optical intensity due to scattering. However, unlike the fiber-bending, no abrupt decrease in optical intensity occurs even below a particular threshold value.

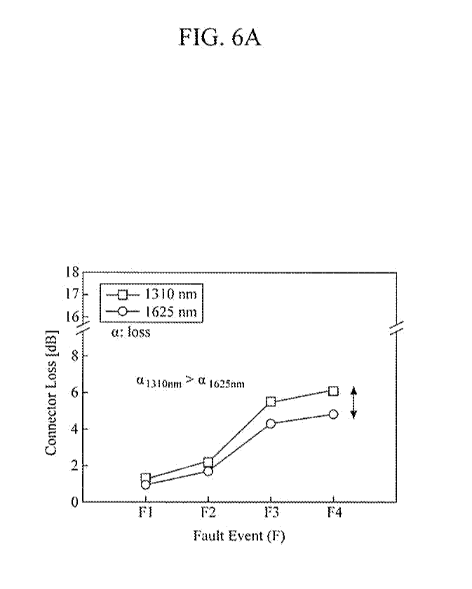

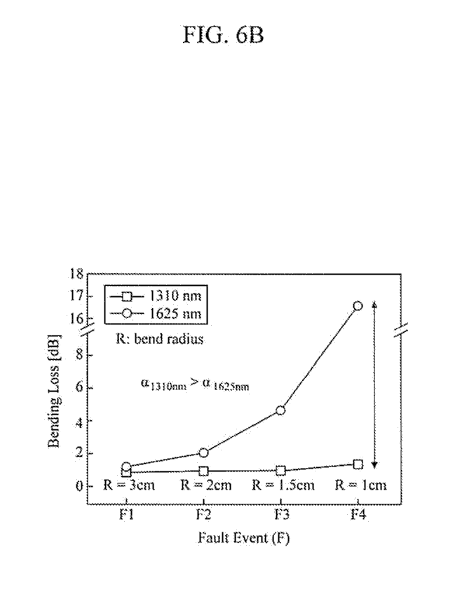

FIGS. 6A and 6B are graphs showing measurements of losses due to a connector mismatch and fiber-bending.

A temperature rise may cause a stimulated thermal Rayleigh scattering (STRS) in which part of an optical signal propagating within an optical fiber is coupled to a scattered signal due to thermal-optics effects. Hence, as the temperature rises, an amount of back-scattered signal increases. In contrast, when the temperature is lowered, part of an optical signal is prevented s from being coupled to a scattered signal, so that the amount of back-scattered signal is reduced.

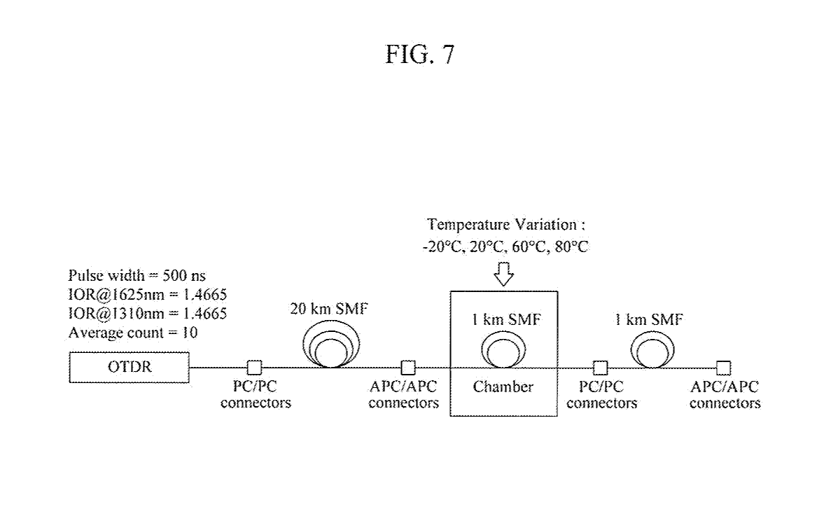

FIG. 7 is a diagram illustrating an experiment measuring a change in a back-scattered signal according to temperature variation.

Referring to FIG. 7, a test link consists of one 20-km optical fiber spool and two 1-km optical fiber spools; and a back-scattered signal is measured by placing one 1-km spool in a chamber and changing a temperature of a chamber from −10 to 80° C.

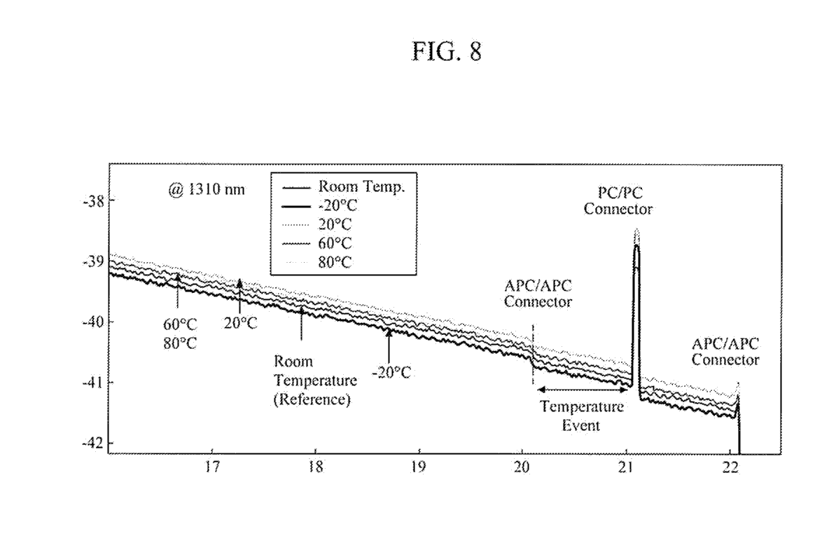

FIG. 8 is a graph illustrating an OTDR trace that shows a change in a back-scattered signal according to temperature variation.

Referring to FIG. 8, as a temperature rises, the linear slope of the OTDR trace moves upward, and when a temperature drops to −20 ° C., the linear slope of the OTDR trace moves is downward.

As described above, it may be possible to distinguish among faults caused by a cut in an optical fiber, longitudinal connector-mismatch, lateral connector-mismatch, fiber bending, and abnormal temperature variation.

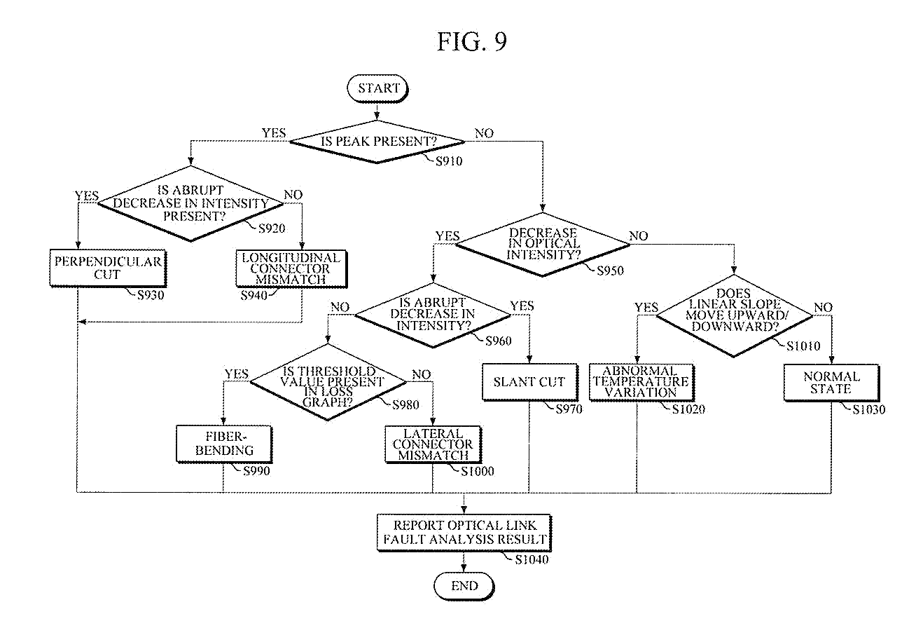

FIG. 9 is a flowchart illustrating a method of analyzing a fault according to an exemplary embodiment.

Referring to FIG. 9, an apparatus for analyzing an optical link fault determines whether a peak is present on an OTDR trace in S910. Based on the presence of the peak, it may be possible to distinguish between a reflective fault and a non-reflective fault.

In response to a determination in S910 that there is no peak, i.e., that a reflective fault occurs, the apparatus determines, in S920, whether or not an optical intensity decreases. In response to a determination in S920 that an abrupt decrease in optical intensity is present, the apparatus diagnoses the fault as being caused by a perpendicular cut made in the optical fiber in S930. In response to a determination in S920 that there is no abrupt decrease, the apparatus diagnoses the fault as being caused by a longitudinal cut made in the optical fiber in S940. That is, the abrupt decrease in optical intensity is diagnosed as a reflective fault caused by a perpendicular cut in the optical fiber, and the small peak is diagnosed as a reflective fault caused by a longitudinal connector-mismatch.

In response to a determination in S910 that there is a peak, i.e., that there is a non-reflective fault, the apparatus determines whether an optical intensity decreases in S950.

In response to a determination in S950 that there is a decrease in optical intensity, the apparatus determines whether the optical intensity decreases abruptly in S960. In response to a determination in S960 that there is an abrupt decrease in optical intensity, the apparatus is diagnoses the non-reflective fault as being caused by a slanted cut made in the optical fiber in S970.

In response to a determination in S960 that there is no abrupt decrease in optical intensity, the apparatus determines whether a threshold value is present in a loss graph in S980.

In response to a determination in S980 that there is a threshold value in the loss graph, the apparatus diagnoses the non-reflective fault as being caused by fiber-bending in S990. In response to a determination in S980 that there is no threshold value in the loss graph, the apparatus diagnoses the non-reflective fault as being caused by lateral connector-mismatch in S1000.

In response to a determination in S950 that there is no decrease in optical intensity, the apparatus determines whether a linear slope moves upward or downward in S1010. In response to a determination in S1010 that the linear slope moves upward or downward, the apparatus diagnoses the non-reflective fault as being caused by abnormal temperature variation in S1020. In response to a determination in S1010 that the linear slope does not move in any direction, the apparatus diagnoses the optical link as being in a normal state in S1030.

Then, the apparatus reports the optical link fault analysis result in S1040.

According to the above exemplary embodiments, causes of reflective and non-reflective faults on an optical link that constitutes a passive optical network (PON) are accurately identified, thereby making it possible to reduce OPEX. In addition, the apparatus and method described above are easy to implement only by upgrading software, which is an analysis tool, in an existing instrument, without hardware replacement, and so the installation cost can be reduced.

A number of examples have been described above. Nevertheless, it will be understood that various modifications may be made. For example, suitable results may be achieved if the is described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of analyzing an optical link fault, the method comprising:
determining whether a peak is present on an optical time domain reflectometry (OTDR) trace;
in response to a determination that the peak is on the OTDR trace, determining a fault as a reflective fault; and
in response to a determination that there is no peak on the OTDR trace, determining the fault as a non-reflective fault.

2. The method of claim 1, wherein the determining of the fault as a reflective fault comprises, in response to a presence of an abrupt decrease in intensity on the OTDR trace, diagnosing that the fault is a reflective fault caused by a perpendicular cut made in an optical fiber.

3. The method of claim 1, wherein the determining of the fault as a reflective fault comprises, in response to an absence of an abrupt decrease in intensity on the OTDR trace, diagnosing the fault as being a reflective fault caused by longitudinal connector-mismatch.

4. The method of claim 1, wherein the determining of the fault as a non-reflective fault comprises, in response to an abrupt decrease in optical intensity on the OTDR trace, diagnosing that the fault is a non-reflective fault caused by a slant cut made in an optical fiber.

5. The method of claim 4, wherein the determining of the fault as a non-reflective fault comprises, in response to a non-abrupt decrease in optical intensity on the OTDR trace, determining whether there is a threshold value in a loss graph, and, in response to a presence of a threshold value in the loss graph, diagnosing that the fault is a non-reflective fault caused by fiber-bending.

6. The method of claim 5, wherein the determining of the fault as a non-reflective fault comprises, in response to an absence of a threshold value in the loss graph, diagnosing the fault as a non-reflective fault caused by lateral connector-mismatch.

7. The method of claim 1, wherein the determining of the fault as a non-reflective fault comprises determining whether an optical intensity decreases, in response to a determination that the optical intensity does not decrease, determining whether a linear slope moves upward or downward, and in response to a determination that the linear slope moves is upward or downward, diagnosing the fault as a non-reflective fault caused by abnormal temperature variation.

8. An apparatus for analyzing an optical link fault, the apparatus comprising:
a peak detector configured to determine whether a peak is present on an optical time domain reflectometry (OTDR) trace;
a reflective fault detector configured to, in response to a determination that a peak is present on the OTDR trace, determine a fault as a reflective fault; and
a non-reflective fault detector configured to, in response to a determination that a peak is not present on the OTDR trace, determine a fault as a non-reflective fault.

9. The apparatus of claim 8, wherein the reflective fault detector is configured to, in response to a presence of an abrupt decrease in intensity on the OTDR trace, diagnose the fault as being caused by a perpendicular cut made in an optical fiber.

10. The apparatus of claim 8, wherein the reflective fault detector is configured to, in response to an absence of an abrupt decrease in intensity on the OTDR trace, diagnose the fault as being a reflective fault caused by longitudinal connector-mismatch.

11. The apparatus of claim 8, wherein the non-reflective fault detector is configured to, in response to an abrupt decrease in optical intensity on the OTDR trace, diagnose that the fault is a non-reflective fault caused by a slant cut made in an optical fiber.

12. The apparatus of claim 11, wherein the non-reflective fault detector comprises, is in response to a non-abrupt decrease in optical intensity on the OTDR trace, determine whether a threshold value is present on a loss graph, and in response to a determination that the threshold value is present on the loss graph, diagnose the fault as a non-reflective fault caused by fiber-bending.

13. The apparatus of claim 12, wherein the non-reflective fault detector is configured to, in response to an absence of the threshold value on the loss graph, diagnose the fault as a non-reflective fault caused by lateral connector-mismatch.

14. The apparatus of claim 8, wherein the non-reflective fault detector is configured to, in response to a determination that an optical intensity does not decrease, determine whether a linear slope moves upward or downward, and in response to a determination that the linear slope moves upward or downward, diagnose the fault as a non-reflective fault caused by abnormal temperature variation.
